(19) United States
(12) Patent Application Publication
(10) Pub. No.: US 2018/0346138 A1
(43) Pub. Date: Dec. 6, 2018

(54) AIRCRAFT PROPULSION SYSTEM COMPRISING A NACELLE WITH AN ENHANCED OPENING SYSTEM

(71) Applicant: Airbus Operations SAS, Toulouse (FR)

(72) Inventors: Frédéric RIDRAY, L'ISLE JOURDAIN (FR); Lionel CZAPLA, CORNEBARRIEU (FR); Frédéric PIARD, TOURNEFEUILLE (FR)

(21) Appl. No.: 15/984,622

(22) Filed: May 21, 2018

(30) Foreign Application Priority Data
May 30, 2017 (FR) 1754741

(51) Int. Cl. B64D 29/06; F02K 1/72; B64D 27/26; B64D 27/18

(52) U.S. Cl. CPC B64D 29/06; F02K 1/72; F05D 2220/323; B64D 27/18; B64D 27/26

(57) ABSTRACT

A propulsion system comprising a pylon, a turbomachine with a core and a nacelle. The nacelle comprises two inner cowls and two outer cowls around the inner cowls, where each outer cowl is mounted articulated via hinges and is mobile between a closed position in which the outer cowl is tightened around the core and an open position in which the outer cowl is separated from the core. Furthermore, each inner cowl is mounted articulated on the pylon via fixed hinges and is mobile between a closed position in which the inner cowl is tightened around the core and an open position in which the inner cowl is separated from the core. The placement of the hinges between the pylon and each inner cowl makes it possible to separate the rotation of the inner cowl from the rotation of the associated outer cowl.

### CROSS-REFERENCES TO RELATED APPLICATIONS

This application claims the benefit of the French patent application No. 1754741 filed on May 30, 2017, the entire disclosures of which are incorporated herein by way of reference.

### TECHNICAL FIELD

The present invention relates to a propulsion system of an aircraft comprising a nacelle for a turbomachine which comprises an enhanced opening system. The present invention relates also to an aircraft comprising at least one such propulsion system.

### BACKGROUND OF THE INVENTION

FIG. 6 is a rear view of a propulsion system 600 of the prior art for an aircraft. The aircraft comprises a fuselage on either side of which is fixed a wing 602. The propulsion system 600 comprises a pylon 604, a turbomachine 606 having a core 608 and a nacelle 610.

The pylon 604 is fixed under the wing 602 and it bears the core 608 and the nacelle 610.

In order to ensure the maintenance of the turbomachine 606, the nacelle 610 has cowls which are mobile between a closed position in which the cowls are tightened around the core 608 and an open position in which the cowls are separated around the core 608.

In particular, the nacelle 610 has two inner cowls 612a-b (also called IFS, for Internal Fixed Structure) and two outer cowls 614a-b (also called OS, for Outer Structure).

Each cowl 612a-b, 614a-b overall takes the form of a half-cylinder and the nacelle 610 has, on either side of a substantially median vertical plane passing through the central axis of the core 608, an inner cowl 612a-b and an associated outer cowl 614a-b.

In the closed position, the two inner cowls 612a-b abut and overall form a cylinder which surrounds the core 608 and constitutes the inner part of a secondary stream and the two outer cowls 614a-b abut and overall form a cylinder which surrounds the inner cowls 612a-b and constitutes the outer part of the secondary stream.

Each outer cowl 614a-b is mounted articulated on the pylon 604 via hinges whose axes are overall parallel to the longitudinal axis of the turbomachine 606. Each inner cowl 612a-b is fixed to the associated outer cowl 614a-b and the fixing is ensured by bottom structural elements 616a-b and top structural elements 618a-b. Thus, for each outer cowl 614a-b, the associated inner cowl 612a-b is fixed to the outer cowl 614a-b in the bottom part by a bottom structural element 616a-b and in the top part by a top structural element 618a-b.

The opening of the inner cowls 612a-b is limited by the opening of the outer cowls 614a-b, the opening of which is itself limited by the proximity of the wing 602.

The limited opening of the inner cowls 612a-b does not therefore facilitate the maintenance work.

### SUMMARY OF THE INVENTION

One object of the present invention is to propose a propulsion system which comprises a nacelle equipped with an enhanced opening system and which makes it possible to increase the opening of the inner cowls and thus facilitate the maintenance work.

To this end, a propulsion system for an aircraft is proposed comprising:

a pylon,

a turbomachine with a core fixed to the pylon, and

a nacelle in which is housed the turbomachine and which comprises:

two inner cowls arranged around the core, and

two outer cowls arranged around the inner cowls, each outer cowl comprising an upstream part and a downstream part which extends to the rear of the upstream part and which is mobile in translation relative to the upstream part between an advanced position in which the downstream part is close to the upstream part and a retracted position in which the downstream part is separated from the upstream part to clear a window, the outer cowls being mobile between a closed position in which the outer cowls are tightened around the core and an open position in which the outer cowls are separated from the core, each upstream part having a half-crown ring,

reversing flaps in which each is mounted articulated on a downstream part and mobile between a retracted position in which the reversing flap blocks the window and a deployed position in which the reversing flap does not block the window,

for each reversing flap, an arm mounted articulated by one of its ends on the flap and by its other end on a half-crown ring,

each inner cowl being mounted articulated on the pylon via at least one inner hinge and is mobile between a closed position in which the inner cowl is tightened around the core and an open position in which the inner cowl is separated from the core.

Such an implementation of the inner cowls makes it possible to increase the opening of these inner cowls independently of the limited opening of the outer cowls and thus facilitates engine maintenance and dismantling and does so despite the presence of reversing flaps.

According to a particular embodiment, each outer cowl is mounted articulated on the pylon via outer hinges.

According to another particular embodiment, the turbomachine comprises a fan housing, and each outer cowl is mounted articulated on the fan housing via outer hinges.

Advantageously, the core comprises, on its periphery, a first groove delimited by an upstream flank and a downstream flank, each inner cowl has a rib which extends radially inside the inner cowl and which is accommodated in the first groove in the closed position, the core comprises, on its periphery, a second groove delimited by an upstream flank and a downstream flank, each half-crown ring has a rib which extends radially on an upstream face of the half-crown ring and which is accommodated in the second groove in the closed position, the downstream flank of the second groove is separated from the upstream flank of the first groove by a recess in which the half-crown ring is positioned in the closed position.

The invention also proposes an aircraft comprising a wing to which is fixed a propulsion system according to one of the preceding variants.

### BRIEF DESCRIPTION OF THE DRAWINGS

The features of the invention mentioned above, and others, will become more clearly apparent on reading the following description of an exemplary embodiment, the description being given in relation to the attached drawings, in which:

FIG. 1 is a side view of an aircraft according to the invention,

FIG. 2 is a side view and in cross section through a median plane of a propulsion system according to the invention in an advanced position,

FIG. 3 is a view similar to that of FIG. 2 in a retracted position,

FIG. 4 is a rear view of the propulsion system according to the invention in an open position,

FIG. 5 is an enlargement of the detail V of FIG. 2, and

FIG. 6 is a rear view of a propulsion system of the prior art.

### DETAILED DESCRIPTION OF THE PREFERRED EMBODIMENTS

In the following description, the terms relating to a position are taken with reference to an aircraft in advancing position, that is to say, as is represented in FIG. 1.

FIG. 1 shows an aircraft 100 which comprises a fuselage 102 and a wing 104 on each side of the fuselage 102. Under each wing 104, the aircraft 100 has a propulsion system 150 which comprises a pylon 152, a turbomachine and a nacelle 154. The pylon 152 is fixed under the structure of the wing 104. The nacelle 154 is also fixed to the pylon 152 and the turbomachine is housed inside the nacelle 154.

In the following description and by convention, X denotes the longitudinal axis of the aircraft 100 oriented positively in the direction of advance of the aircraft 100, Y denotes the transverse direction which is horizontal when the aircraft is on the ground and Z denotes the vertical direction or vertical height when the aircraft is on the ground, these three directions X, Y and Z being mutually orthogonal. The longitudinal axis of the nacelle 154 and of the turbomachine is parallel to the longitudinal axis X.

FIG. 2 shows the propulsion system 150 with the turbomachine 202 and the nacelle 154 in an advanced position and FIG. 3 shows the propulsion system 150 with the nacelle 154 in a retracted position.

Inside the nacelle 154 is housed the turbomachine 202 which comprises a core 204 which is fixed to the pylon 152 via a front engine attachment and a rear engine attachment. The turbomachine 202 also comprises a fan housing 206 in which is housed a fan 208 to the rear of which extends a secondary stream 210 in which circulates a secondary flow 212 originating from the air intake through the fan 208.

As for the nacelle of the prior art, the nacelle 154 according to the invention has two inner cowls 256a-b (also called IFS, for Internal Fixed Structure) and two outer cowls 258a-b (also called OS, for Outer Structure).

The secondary stream 210 is delimited behind the fan 208 between the inner cowls 256a-b and the outer cowls 258a-b.

Each outer cowl 258a-b comprises an upstream part 259a-b which is fixed in flight and a downstream part 257a-b which extends to the rear of the upstream part 259a-b and which, in the braking phase, is mobile in translation relative to the upstream part 259a-b overall parallel to the longitudinal axis of the nacelle 154.

The downstream parts 257a-b are mobile between an advanced position (FIG. 2) and a retracted position (FIG. 3) and vice versa. In the advanced position, each downstream part 257a-b is positioned as far forward as possible so as to be close to the corresponding upstream part 259a-b in order to form an aerodynamic continuity. In the retracted position, each downstream part 257a-b is positioned as far behind as possible so as to be separated from the corresponding upstream part 259a-b to clear a window 216 between the secondary stream 210 and the outside.

The nacelle 154 comprises an actuation system ensuring the translational displacement of the downstream parts 257a-b from the advanced position to the retracted position and vice versa. The actuation system comprises, for example, one or more motors or one or more power cylinders, where each is controlled by a control unit, for example of the processor type, which controls the displacements in one direction or in the other according to the needs of the aircraft 100.

In the retracted position, the window 216 is delimited upstream relative to the longitudinal axis X by the upstream parts 259a-b and downstream relative to the longitudinal axis X by the downstream parts 257a-b.

In the embodiment of the invention presented here, the downstream parts 257a-b bear cascades 218 and in the retracted position, the cascades 218 are located facing the window 216.

The nacelle 154 also comprises reversing flaps 214 where each is mounted articulated on a downstream part 257a-b. Each reversing flap 214 is mobile between a retracted position (FIG. 2) and a deployed position (FIG. 3), and vice versa.

In the retracted position, each reversing flap 214 blocks the window 216 and is not across the secondary stream 210. In the deployed position, each reversing flap 214 does not block the window 216 and is oriented towards the core 204 across the secondary stream 210 allowing the secondary flow 212 of the secondary stream 210 to pass outside.

Each inner cowl 256a-b and outer cowl 258a-b overall takes the form of a half-cylinder and the nacelle 154 has, on either side of a substantially median vertical plane passing through the central axis of the core 204, an inner cowl 256a-b and an associated outer cowl 258a-b. Thus, the inner cowls 256a-b are arranged around the core 204 and the outer cowls 258a-b are arranged around the inner cowls 256a-b.

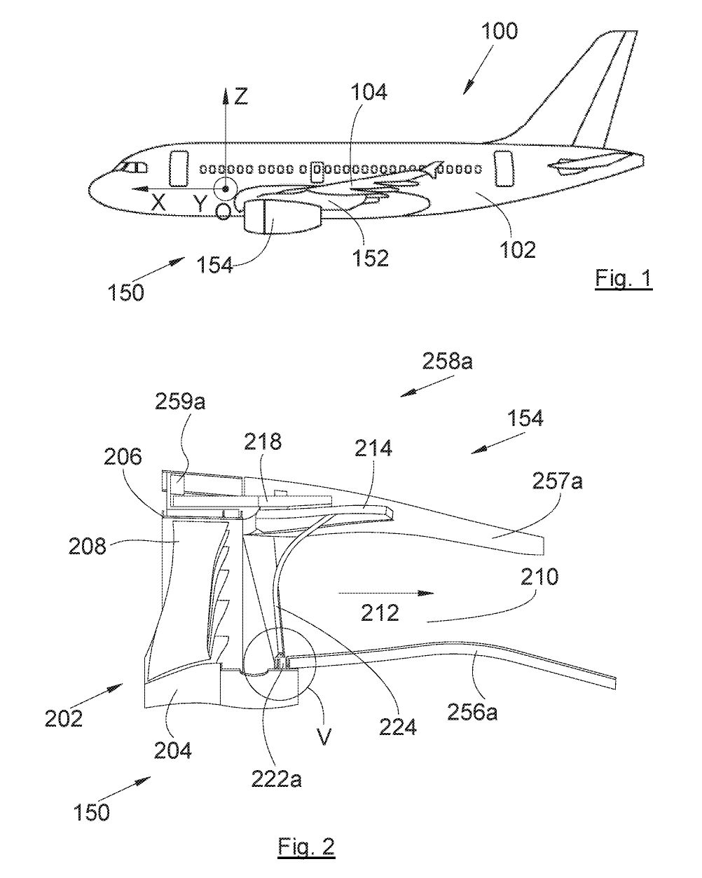

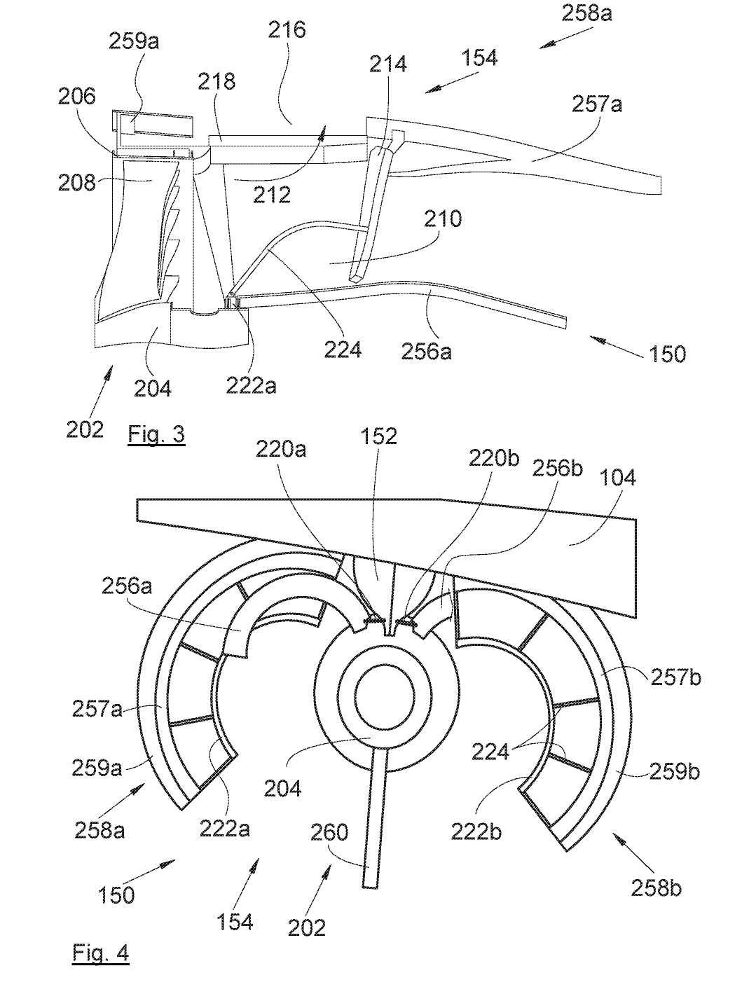

Each inner cowl 256a-b and outer cowl 258a-b is articulated between an open position and a closed position. FIG. 4 shows the nacelle 154 with the cowls in open position which is a position used, in particular, in the context of the maintenance of the propulsion system 150. The closed position constitutes the normal position of use of the propulsion system 150. For reasons of legibility in FIG. 4, one of the inner cowls 256b has been cut.

In the closed position, the two inner cowls 256a-b abut and overall form a cylinder which surrounds and bears on the core 204 and constitutes the inner part of the secondary stream 210 and the two outer cowls 258a-b overall form a cylinder which surrounds the inner cowls 256a-b and constitutes the outer part of the secondary stream 210.

Each outer cowl 258a-b is mounted articulated on a fixed structure via outer hinges and is mobile between a closed position in which the outer cowl 258a-b is tightened around the associated inner cowl 256a-b and therefore the core 204 and an open position in which the outer cowl 258a-b is separated from the core 204.

According to a first embodiment, the fixed structure is the pylon 152 and each outer cowl 258a-b is then mounted articulated on the pylon 152, in particular, in the case where the pylon 152 has a front attachment on the fan housing 206.

According to a second embodiment, the fixed structure is the fan housing 206 directly or indirectly through a structure borne by the fan housing 206 and each outer cowl 258a-b is mounted articulated on the fan housing 206, in particular, in the case where the pylon 152 has a front attachment on the core 204.

Each inner cowl 256a-b is mounted articulated on the pylon 152 via at least one inner hinge 220a-b and is mobile between a closed position in which the inner cowl 256a-b is tightened around the core 204 and an open position in which the inner cowl 256a-b is separated from the core 204.

The outer hinges which are associated with the outer cowls 258a-b are distinct from the inner hinges 220a-b which are associated with the inner cowls 256a-b.

The placement of the inner hinges 220a-b between the pylon 152 and each inner cowl 256a-b makes it possible to separate the rotation of the inner cowl 256a-b from the rotation of the associated outer cowl 258a-b and therefore to be able to increase the opening of the inner cowls 256a-b without increasing the opening of the outer cowls 258a-b.

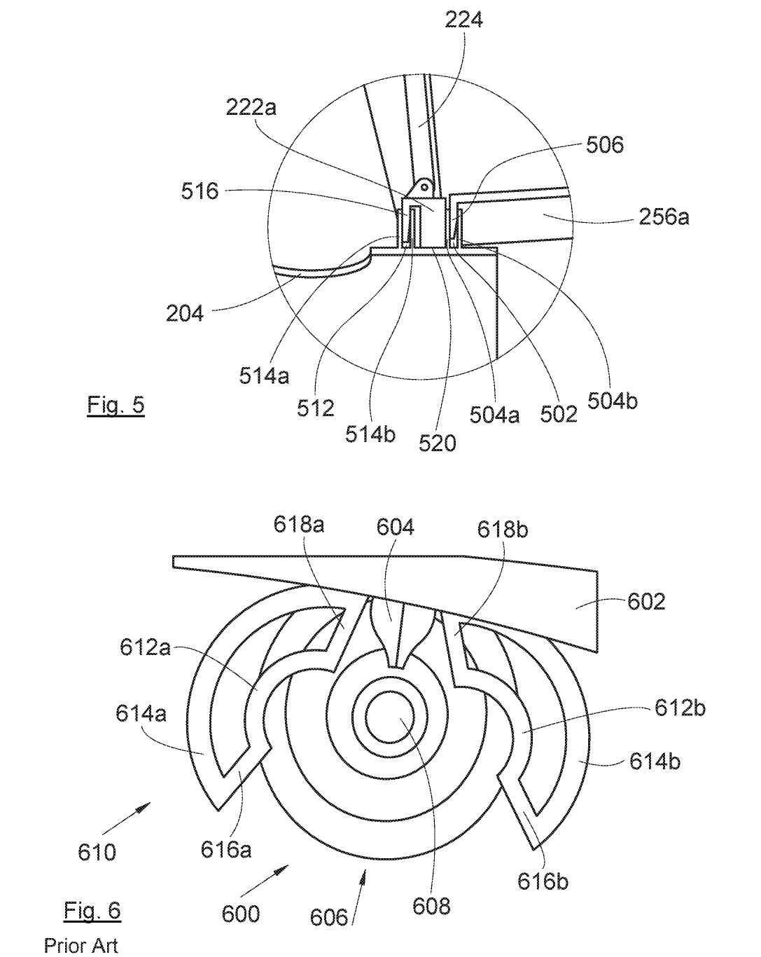

FIG. 5 shows an enlargement of the zone of attachment on the core 204.

Each upstream part 259a-b also has a half-crown ring 222a-b which is overall concentric with the upstream part 259a-b and which, like the inner cowls 256a-b, abut in the closed position and overall form a crown ring which surrounds and bears on the core 204.

For each reversing flap 214, the nacelle 154 has an arm 224 which is mounted articulated by one of its ends on the flap 214 and by its other end on a half-crown ring 222a-b.

Thus, in the transition from the advanced position to the retracted position, the translational displacement of a reversing flap 214 by virtue of the translational displacement of the downstream parts 257a-b and the holding in position of the half-crown rings 222a-b result in a pivoting of each arm 224 and therefore of the reversing flap 214 which is fixed thereto in the direction making it possible to reach the deployed position. Conversely, the transition from the retracted position to the advanced position allows the reversing flap 214 to reach the retracted position.

The arrangement of the arms 224 on the half-crown rings 222a-b distinct from the inner cowls 256a-b allows the concurrent openings of the inner cowls 256a-b and of the outer cowls 258a-b. In effect, if the arms 224 were fixed to the inner cowls 256a-b, these dissociated openings would not be possible.

To lock the inner cowls 256a-b to one another in the closed position at least one lock is provided which locks the edges of the two inner cowls 256a-b to one another. In particular, a lock is arranged facing each inner hinge 220a-b or can be offset depending on the mechanical requirement.

Likewise, to lock the outer cowls 258a-b to one another in the closed position, at least one lock is provided which locks the edges of the two outer cowls 258a-b to one another.

To ensure the structural strength in the six o'clock zone of the nacelle 154 in the closed position, the propulsion system 150 has a structural element 260, which overall takes the form of an aerodynamic pylon, which is fixed in the bottom part of the core 204 at the median plane and which points downwards. The various engine and drainage systems run inside the structural element 260.

In the closed position, the inner cowls 256a-b are secured in a seal-tight manner around the structural element 260 and the structural element 260 extends on either side of the inner cowls 256a-b.

Likewise, the outer cowls 258a-b are secured in a seal-tight manner at the end of the structural element 260.

The securing of the outer cowls 258a-b and of the inner cowls 256a-b to the structural element 260 is performed by any appropriate fixing means, such as locks.

FIG. 5 shows more particularly a linkage mode between the core 204 and the inner cowls 256a-b, on the one hand, and the half-crown rings 222a-b, on the other hand

The core 204 comprises, on its periphery, a first groove 502 delimited by an upstream flank 504a and a downstream flank 504b and each inner cowl 256a-b has a rib 506 which extends radially inside the inner cowl 256a-b and which is accommodated in the first groove 502 in the closed position.

The core 204 comprises, on its periphery, a second groove 512 delimited by an upstream flank 514a and a downstream flank 514b and each half-crown ring 222a-b has a rib 516 which extends radially on an upstream face of the half-crown ring 222a-b and which is accommodated in the second groove 512 in the closed position.

The first groove 502 is downstream of the second groove 512 and the downstream flank 514b of the second groove 512 is separated from the upstream flank 504a of the first groove 502 by a recess 520 in which the half-crown ring 222a-b is positioned in the closed position to come to bear against the core 204.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A propulsion system for an aircraft and comprising:
a pylon,
a turbomachine with a core fixed to the pylon, and
a nacelle in which is housed the turbomachine is and which comprises:
two inner cowls arranged around the core where each inner cowl is mounted articulated on the pylon via at least one inner hinge and is mobile between a closed position in which the inner cowl is tightened around the core and an open position in which the inner cowl is separated from the core,
two outer cowls arranged around the inner cowls, each outer cowls comprising an upstream part and a downstream part extending at the rear of the upstream part and which is mobile in translation relative to the upstream part between an advanced position in which the downstream part is close to the upstream part and a retracted position in which the downstream part is separated from the upstream portion to clear a window, the outer cowls being mobile between a closed position in which the outer cowls are tightened around the core and an open position in which the outer cowls are separated from the core, each upstream part having a half-crown, wherein in the closed position, the two crown rest on the core,
reversing flaps in which each is mounted articulated on a downstream part and mobile between a retracted position in which the reversing flap blocks the window and a deployed position in which the reversing flap does not block the window,
for each reversing flap, an arm mounted articulated by one of its ends on said flap and by its other end on a half-crown ring.

2. The propulsion system to claim 1, wherein each outer cowl is mounted articulated on the pylon via outer hinges.

3. The propulsion system according to claim 1, wherein the turbomachine comprises a fan housing, and wherein each outer cowl is mounted articulated on the fan housing via outer hinges.

4. The propulsion system according to claim 1,
wherein the core comprises, on its periphery, a first groove delimited by an upstream flank and a downstream flank,
wherein each inner cowl has a rib which extends radially inside said inner cowl and which is accommodated in the first groove in the closed position,
wherein the core comprises, on its periphery, a second groove delimited by an upstream flank and a downstream flank,
wherein each half-crown ring has a rib which extends radially on an upstream face of said half-crown ring and which is accommodated in the second groove in the closed position,
wherein the downstream flank of the second groove is separated from the upstream flank of the first groove by a recess in which the half-crown ring is positioned in the closed position.

5. An aircraft comprising a wing to which is fixed a propulsion system according to claim 1.
